(19) United States
(12) Patent Application Publication
(10) Pub. No.: US 2006/0072532 A1
(43) Pub. Date: Apr. 6, 2006

(54) Method and system for proactive setup of multicast distribution tree at a neighbor cell or subnet during a call

(75) Inventors: Jheroen P. Dorenbosch, Paradise, TX (US); Andrew T. Morrison, Euless, TX (US); Cynthia M. Jung, Menlo Park, CA (US)

Correspondence Address: MOTOROLA, INC., 1303 EAST ALGONQUIN ROAD, IL01/3RD, SCHAUMBURG, IL, 60196, US

(73) Assignee: Motorola, Inc.

(21) Appl. No.: 10/955,472

(22) Filed: Sep. 30, 2004

(51) Int. Cl. H04B 7/216

(52) U.S. Cl. 370/342

(57) ABSTRACT

A system and method in a radio access network (RAN) (100) consisting of wireless access points (APs) and (RR4, RR5, RR6, and RR7) mobile stations (MSs) (102) that proactively sets up a multicast distribution tree (101). An indication is detected at a destination AP (RR6). The indication is that an MS (102) operating at an initial AP (RR5) is a member of a multicast group. The indication is via a device operating in the RAN (100). Responsive to detecting the indicating, a multicast distribution tree (101) is established for the multicast group that includes the destination AP (RR6).

### FIELD OF THE INVENTION

The invention relates to communication systems and individual components within these systems. More specifically, the invention relates to conducting communications between communication system components.

### BACKGROUND

Internet Protocol (IP) multicast routing (“multicast”) is a method of transmitting datagrams between a finite set of hosts, which are members of a multicast group. Multicast communications differ from unicast communications, where datagrams are transmitted only between two end points, and from broadcast communications, where datagrams are transmitted from a single source to all hosts within a network or group. Multicast communications are often made in a network, which has been organized into sub-networks (“subnets”) or cells.

As is known, in wireless communication systems, a wireless IP mobile station (MS) may belong to or become a member of one or more multicast groups. The MS also may change access points in the wireless communication system. When the wireless IP MS changes access points, it may also change the subnet or cell where it resides. In previous systems, if the MS transitions to a new subnet or cell, the MS must inform the access point on the subnet of the multicast addresses of the one or more groups to which the MS belongs. To achieve this result, some previous system's MSs transmit one or more “Multicast Join” messages (according to the Internet Group Management Protocol (IGMP)) to the access point. Multicast Join messages, or Join messages, may be one of an Internet Group Management Protocol (IGMP) Membership Report message or a Multicast Listener Discovery (MLD) Multicast Listener Report message for the one or more multicast groups. As a result, the access point joins the multicast distribution trees for the one or more groups and transmits future multicast packets on a downlink communication path to group members. Without the transmission of the Multicast Join messages, the multicast packets for the group members may not reach an individual MS and the MS would miss its multicast calls.

Although allowing for movement between subnets or cells, these previous systems also suffer from several short-comings. For example, it is time-consuming for the system to properly organize the multicast distribution tree during an on-going call. Because the tree organization takes time to accomplish, gaps in calls frequently are the result. Also, if the MS moves frequently among subnets or cells, many Multicast Join messages must be required. These multiple messages require a substantial portion of the stand-by battery power of the MS to be processed resulting in decreased battery power for other functions.

### BRIEF DESCRIPTION OF THE DRAWINGS

FIGS. 1-6 show multicast distribution trees and the movement of a mobile station (MS) within a network according to various embodiments of the present invention;

FIGS. 7-9 show multicast distribution trees and movement of an MS within a network according to various embodiments of the present invention; and

FIGS. 10-16 show multicast distribution trees and the movement of an MS within a network according to various embodiments of the present invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION OF THE PREFERRED EMBODIMENTS

A system and method of proactive setup of a multicast distribution tree at a neighboring access point occurs during an on-going call, ongoing multicast session, or at least while an MS is a member of at least one multicast group. By properly updating the multicast distribution tree for the multicast group before the distributed multicast packets are needed by the call, system performance and response time is enhanced. Additionally, for mobile stations that frequently change subnets, significant power savings also may be realized because the tree has been properly updated before its use is required.

In one approach, an indication is detected at a destination access point (AP) that a mobile station (MS) operating at an initial AP is a member of a multicast group. An MS is operating at an AP after it has successfully associated or registered with that AP, until it has successfully associated or registered with another AP.

The indication may be received via a radio access network (RAN) device (wireless access points or MS). Responsive to the detecting of the indication, a multicast distribution tree for the multicast group is established, extended, or otherwise modified to include the destination AP.

The indication may be received from the initial AP and may be formed responsively to an occurrence of an event. The event may be a location update by the MS at the destination AP; a handoff attempt by the MS to the destination AP; an association of the MS with the initial AP, the destination AP being in close proximity to the initial AP; a detection by the initial AP of a setup of a session for the MS where the session directs multicast data to the MS; an establishment of a multicast distribution tree by the initial AP that includes the destination AP; a context transfer for the MS from the initial AP to the destination AP; a receipt of a Multicast Join message from the MS directed at the initial AP; or a detection by the initial AP that the MS may move from the initial AP to the destination AP. Other examples of events are possible.

The indication may also be received from the MS. In this case, the indication is not an Internet Group Management Protocol (IGMP) Membership Report message or a Multicast Listener Discovery (MLD) Multicast Listener Report message for the multicast group. If received from the MS, the indication may be a location update message by the MS at the destination AP; a pre-association message of the MS with the destination AP; a Half-Join message received from the MS; or a handoff request or handoff initiation message by the MS to the destination AP. Other examples of indications are possible, such as an IGMP Membership Report message or a MLD Multicast Listener Report message for the multicast group.

In another approach, multicast data is received at the destination AP for the multicast group and not transmitted to the MS. This can be done as long as it can safely be assumed that the MS can receive the multicast data via the initial AP. An association request is subsequently received at the destination AP from the MS and after the receiving the association request, receiving subsequent multicast data at the destination AP for the multicast group and transmitting the subsequent multicast data. The association request may be a Multicast Join message for the multicast group; a request message from the MS to operate at the destination AP, an Association Request or a Reassociation Request.

Thus, a system and method as set forth herein allows the proactive setup of the multicast distribution tree before the contents of the tree are needed by an MS that is moving amongst subnets in a network. Substantial performance improvements, such as time savings and power conservation, result from these approaches because there is substantially no waiting time as the MS moves from subnet to subnet.

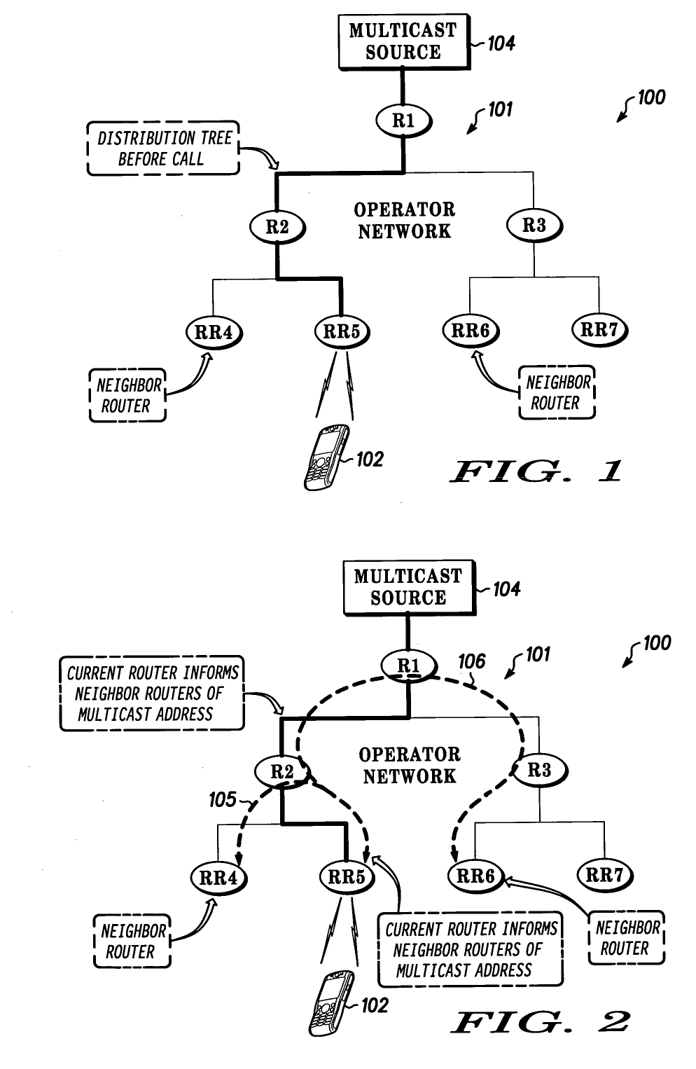

Referring now to FIG. 1, an example of a multicast distribution tree 101 and the movement of an MS within a network is described. A network 100 contains a Radio Access Network (RAN). The RAN includes RAN devices that are wireless access points and MSs. Wireless access points include base stations, cellular base stations, Radio Routers (RRs) or transmitters. Other examples are possible. FIG. 1 shows example RAN devices such as access points RR4, RR5, RR6, and RR7, and Mobile Station (MS) 102. The network 100 also contains routers R1, R2, R3, and R4 that support the distribution of multicast data from multicast sources 206 and 207. Multicast distribution from a multicast source requires the setup of a multicast distribution tree. The multicast distribution tree 101 is created and maintained according to the Protocol Independent Multicast-Sparse Mode (PIM-SM) protocol. Although described in terms of the PIM-SM protocol, other Multicast Routing Protocols (MRPs) can also be used for the trees described herein.

When the MS 102 moves into a cell, it transmits a Multicast Join message for each of its multicast groups or a single Multicast Join message for a plurality of its groups. Specifically, the Multicast Join message may be a Membership Report message according to the IGMP protocol or a Multicast Listener Report message according to the MLD protocol. For each group, the access point associated with the wireless subnet (e. g. RR5) uses a Multicast Join message in order to be added to the distribution tree 101 for the group.

The access points may include transmitters, base stations, and control and routing functionality associated with these elements. In one approach, the access points are Flarion Radio Routers. The multicast distribution tree 101 initially comprises the multicast source 104 as well as routers and access points R1, R2 and RR5. In FIG. 1, the multicast distribution tree 101 is shown before the MS 102 moves from an initial access point to a destination access point.

In this approach, each of the access points RR4, RR5, RR6 and RR7 has a list of the access points that serve the neighboring cells. The list may be saved at a memory at the access point. Third Generation (3-G) and Fourth Generation (4-G) base stations customarily have neighbor cell lists and communicate (via the wired network) with neighboring base stations to facilitate a handoff and perform Mobile IP functions. The neighbor cell list may be used as a list of the access points that serve the neighboring cells, but the list may also be established by different means, such as by separate configuration, by observing transmissions from nearby access points, or by receiving information regarding nearby access points from MSs.

Referring now to FIG. 2, a second diagram showing the movement of the MS 102 is described. The access point RR5 detects that a multicast call is being set up for a group. Preferably, the access point RR5 inspects a call or session setup message being sent that specifies that the call will use the multicast address of the group. Alternatively, the AP may detect a call or session setup message being sent to the multicast address of the group. The access point RR5 may also detect the start of a stream of packets to that address. In addition, the access point RR5 may also receive a message from one of its member MSs that a session is starting, that it wants to initiate a multicast session to the group, or that it is wiling to participate in a multicast session for the group.

The access point RR5 then informs its neighboring access points (e.g. RR6 and RR4) of the multicast address that is being used for the downlink bearer message by sending an indication over paths 105 and 106. RR5 may send the information to the IP address of the neighboring access points, the IP address being available in the list of the access points that serve the neighboring cells.

Each of the access points RR4, RR5, RR6 and RR7 will periodically check that there are still group members on its subnet. In one example, the access points use an IGMP membership query to accomplish this result. Each access point will keep its neighbor access points informed of the result of each query or of the departure of the last member. A neighbor access point serves a cell or subnet in which the multicast call is occurring.

When the neighboring access points RR6 and RR4 receive the information concerning an ongoing session on the multicast address, the access points RR6 and RR4 check whether the access point RR4 or RR6 is already part of the distribution tree 101 for that address. If the access point is not a part of the distribution tree 101 for that address, the access point uses a Multicast Join message to set up the tree 101 and include the access point in the tree 101.

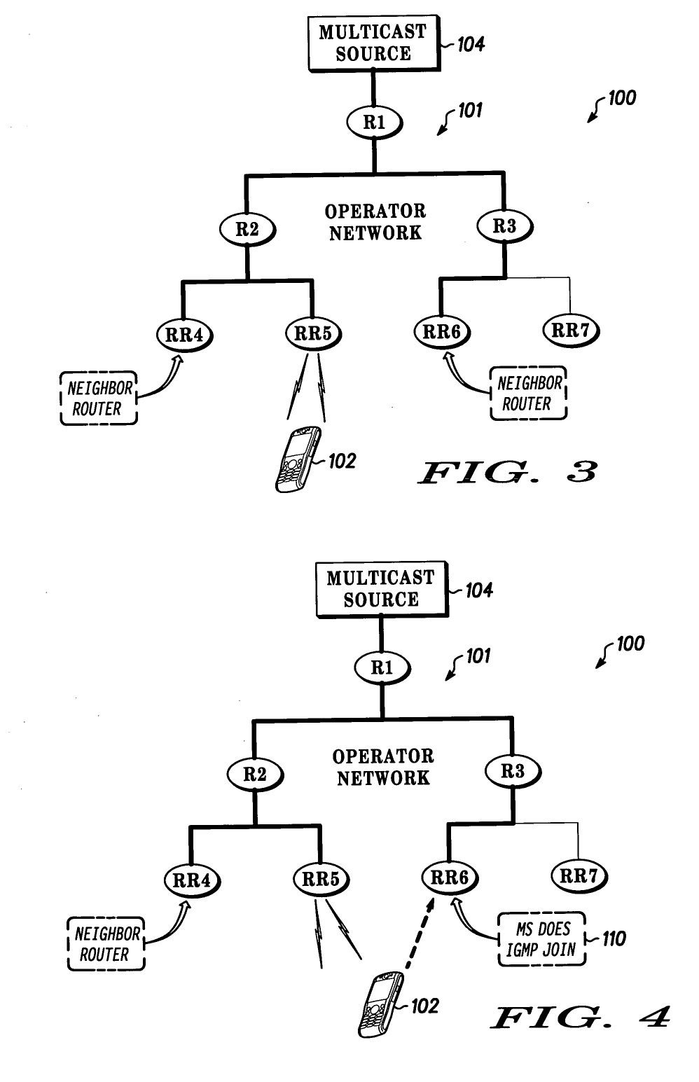

Referring now to FIG. 3, the resulting tree 101 after the above steps are performed includes access points R1, R2, R3, R4, RR5, RR6 and RR7. In a preferred approach, the neighbor access points RR4 and RR6 do not transmit the multicast packets over the air unless members are already present.

Referring now to FIG. 4, the network is shown after setup of multicast transmission and after the MS moves to one of the neighbor access point. When the MS 102 is on the new subnet, the MS 102 transmits a Multicast Join message 110.

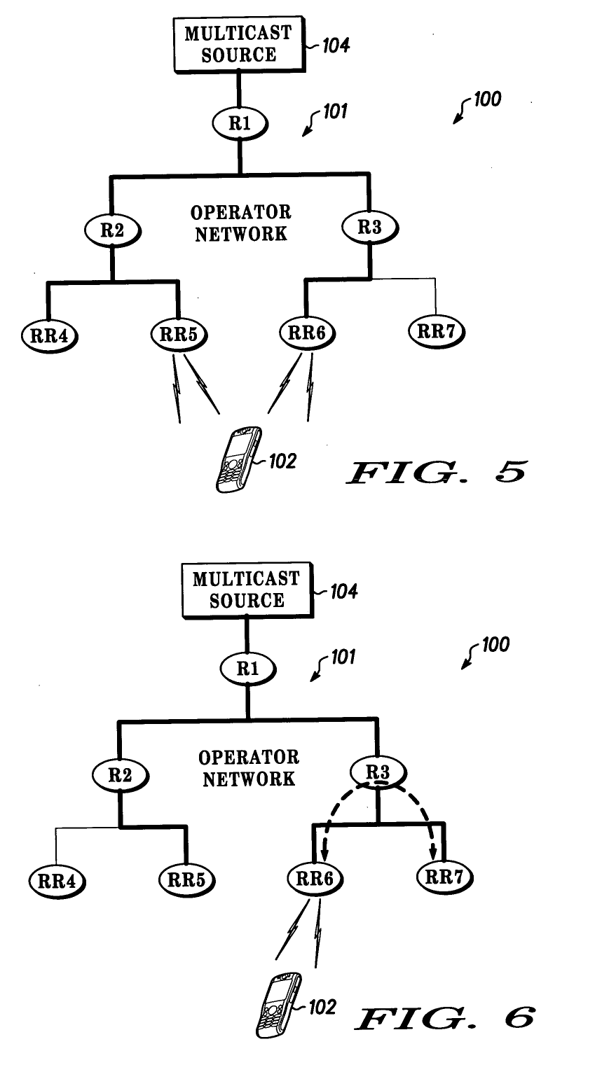

Referring now to FIG. 5, the network after performance of the above steps is described. The access point RR6 has already joined the multicast distribution tree 101. The access point RR6 is now immediately ready to start sending multicast messages over the air to the appropriate MS.

The access points detect that no group members are present on the wireless subnet, for example, from a IGMP membership query or from an IGMP leave message issued by a departing MS. An access point without members no longer transmits data for the group's multicast on the subnet. An access point also informs its neighbors when all members are absent. However, the access point does not leave the multicast distribution tree 101 if a neighbor is serving a call on the multicast address.

Referring now to FIG. 6, the distribution tree and network after the MS 102 has moved to the new access point RR6 is described. The access point RR6 notifies its neighbors RR7 (notification shown) and RR5 (notification not shown) that it has a member of the multicast group. As a result, the access point RR7 joins the tree 101 and the access point RR5 will not leave the tree 101. The access point RR5 discovers that all members are absent and stops transmission of the multicast data. The access point RR5 will also inform its neighbors of the stoppage. As a result, the access point RR4 leaves the multicast distribution tree 101 because RR4 neither serves MSs that are a member of the group, nor does it have a neighbor AP that serves group members.

An access point that is sending downlink multicast packets during a call to members may know the identities of the members in its cell. Moreover, the access point may know where in the cell the members are located. The access point may do unicast pings with the members, query the member MSs for their location, and/or use a directional antenna to accomplish this result.

The access point may use multicast for the call. In this case, the access point will not always inform all neighbor transmitters, but only those with a significant likelihood that the MS 102 that is in the call will roam into the neighbor cell.

Likelihood of roaming for the MS 102 into the neighbor cell can be calculated using several factors. For example, the attenuation with which the transmitter receives the MS 102 may be used. If there is little attenuation the MS 102 is nearby and is not likely to roam into any neighbor cell. In another example, the distance between the MS 102 and the transmitter is measured using signal round-trip time. The shorter the duration of the round-trip time, and hence the closer the MS is to the transmitter, the less the likelihood that the MS will roam into a neighbor cell. In another example, the direction of the MS 102 is measured using a directional antenna. Only neighboring cells in the direction of the MS 102 are informed. In still another example, knowledge of the position of the MS 102 (e.g. using Global Positioning Satellites (GPS) or triangulation techniques is used. Only neighboring access points near the MS are typically informed. The system may also take into account how fast the above measurements are changing, which gives an indication of the speed of the MS and hence the likelihood of moving into the neighbor cell. The direction of motion may also be taken into account.

Destination access points are thus informed when a likelihood exists that an MS may roam into the cell. When the destination access point receives the information about the ongoing session on the multicast address, it checks whether it has sufficient spare capacity on its backhaul communication channel. If sufficient capacity does not exist, the access point ignores the information. The access point joins the distribution tree 101 after the MS 102 sends the Multicast Join message.

A single access point may support multiple cells and/or sectors. In this case, the access point only informs other access points if there are one or more MSs receiving multicast in a cell/sector that is adjacent to a cell/sector supported by the other access point.

Referring to FIGS. 7-9, diagrams showing the movement of an MS 202 from an initial access point to a new access point on a new subnet are described. The network 200 includes a first multicast source 203, second multicast source 204, access points RR5, RR6, RR7, and RR8 connected via routers R1, R2, R3, and R4.

Referring to FIG. 7, the MS 202 moves from an old or initial access point RR6 to a second, destination access point RR7. As described below, with this approach, the MS 202 passes identification or association or pre-association information to the new access point RR7 at step 205 and thereby minimizes the total amount of information that the MS 202 must transmit.

The new or destination access point RR7, as part of the association procedure performed by the MS 202 at step 205, informs the MS 202 whether it supports the method described below for proactive setup of a multicast distribution tree. If the MS 202 learns that the access point RR7 does not support the present approach, the MS 202 will execute the Multicast Join signaling required to set up the distribution trees as in previous systems.

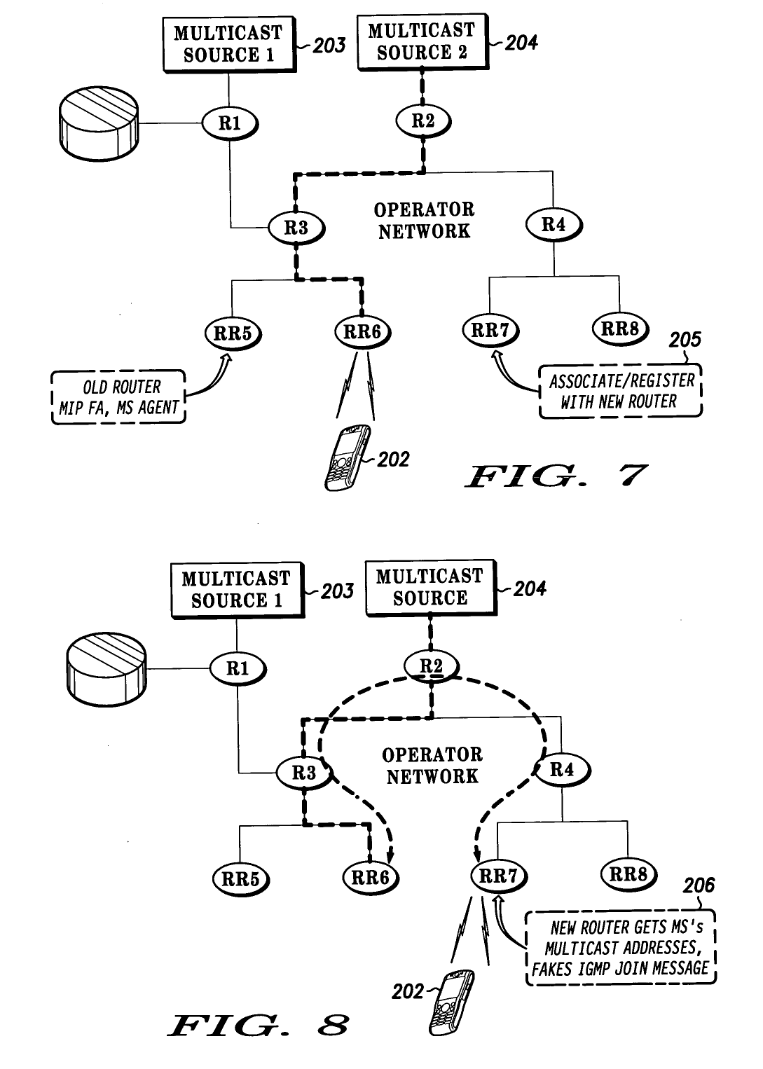

Referring now to FIG. 8, if the new AP RR7 informs the MS 202 that it supports the method, the new access point RR7 (or an agent in the new access point) uses the identifying information from the MS 202 to get, from the MS's old AP, all multicast addresses currently being used by the MS 202 at step 206. Preferably, the MS 202 receives identifying information that allows the new access point RR7 to find the old or initial access point RR6 or an agent in the old access point as shown in FIG. 8. The old access point/old agent RR6 and the new access point/agent RR7 can then collaborate to pass the multicast addresses of the groups of the MS 202 to the new access point/agent RR7. The identifying information may include an identifier that is broadcast by the old access point or may include an IP address that terminates on the old AP or is routed to the old AP. The MS 202 may use the Mobile Internet Protocol. The Mobile Internet Protocol, or Mobile IP (MIP) is described in RFC 2002, which is available at http://www.ietf.org/rfc. For example, if the MS 202 has a MIP home IP address and uses Mobile IP when moving between APs, the identifying information of the MS 202 could contain the old Care Of Address (CoA) of the MS, which is the address used for Mobile IP at the old access point of the MS 202. Alternatively, the information could contain the home address of the MS 202. If the home address is used, the receipt should occur before MIP registration with the home agent is completed. The new access point/agent RR7 can then send a message to the home address, which will be routed—by the MIP protocol—to the old access point RR6.

Alternatively, the access point RR7 may receive the multicast addresses of the MS 202 from a system database using the MS identifier. For example, an International Mobile Subscriber Identity (IMSI) address, Universal Resource Identifier (URI) address or the MS's IP address can be used. The system database may be a home location register (HLR) visitor location register (VLR), a session initiation protocol (SIP) register, an authentication, authorization, and accounting (AAA) element, a provision, a call controller, or call coordination entity database. The database may contain the groups of MSs and the multicast address of the groups.

In another approach, a destination AP that has already proactively joined a multicast distribution tree but is not transmitting multicast data may also start transmitting the multicast data as soon as it receives an association request from the MS. In this way, the MS may not have to send a Multicast Join message and, in any case, the multicast data will be available sooner.

Referring now to FIG. 8, the new access point RR7 now joins the multicast distribution tree 207 for all of the multicast addresses of the MS 202 as shown in FIG. 9. The transmitter will also transmit further multicast packets for those addresses over the air interface. As a result, the MS 202 will receive all of its multicast data without or before having to transmit a Multicast Join message when the MS 202 moves to a new subnet or cell.

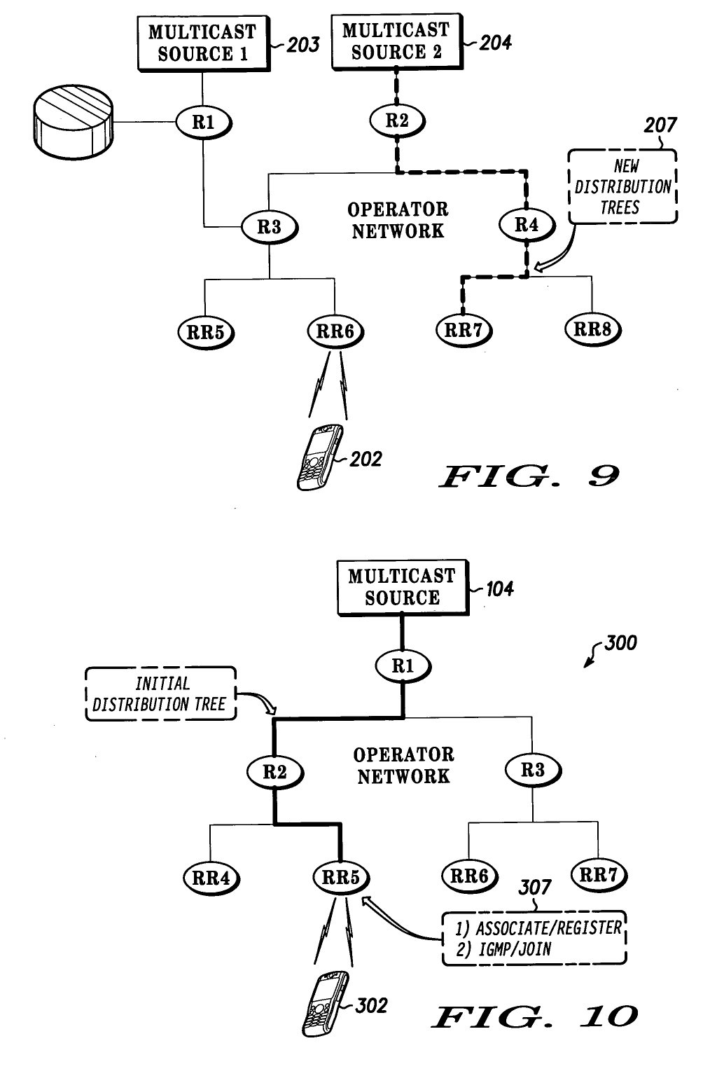

Referring now to FIGS. 10-14, in another approach, an MS 302 operating in a network at an initial AP RR5, transmits a Multicast Join message to the access points of all potential future subnets or cells in preparation for the MS moving to that cell or subnet. A network 300 includes a multicast source 304, the MS 302, routers R1, R2, and R3, and access points RR4, RR5, RR6 and RR7.

By transmitting Multicast Join messages to one or more destination APs before the MS 302 operates at those one or more destination APs, several benefits are obtained. First, simpler radio access points may be used. Second, the method is selective with respect to which access points are asked to join. In other words, the MS 302 only transmits the Multicast Join messages to an access point having a minimum required radio link quality, and will only do so if the probability that it will switch to that access point is high. Various criteria, such as weak current signal, or a determination that the MS 302 is moving may be used for this determination. Third, the approach does not require that a neighbor list be maintained at each access point. The MS 302 can transmit the Multicast Join message to any potential destination access point that it receives at the current location with sufficient signal quality. The joined access point does not have to be a geographic neighbor of the current cell. The MS sends the Multicast Join Message to a potential target or destination AP while it is not operating at the potential target AP.

Referring now to FIG. 10, the MS 302 initiates the setup of the initial multicast distribution tree by sending a Multicast Join message to the initial AP. All data sent to the group address will now be transmitted in the current cell or subnet of the MS 302. When the MS 302 detects one or more cells/subnets that have a high probability to become a handover target cell/subnet, the MS 302 informs the access point of the one or more cells/subnets.

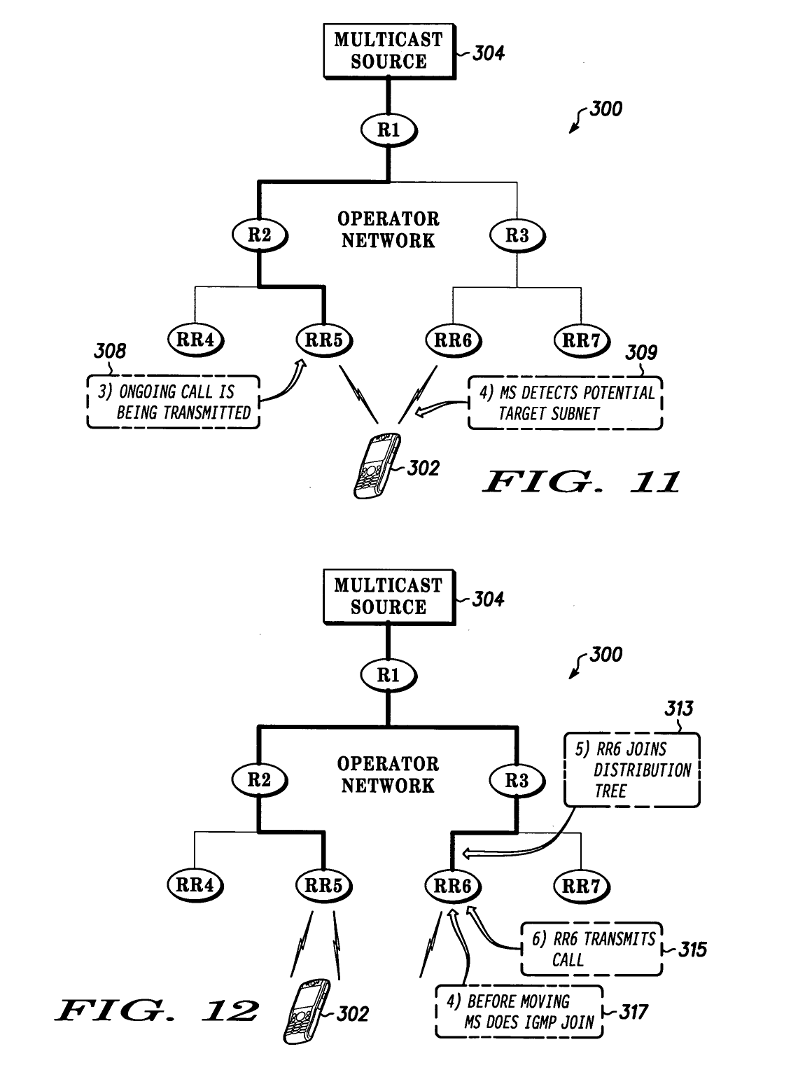

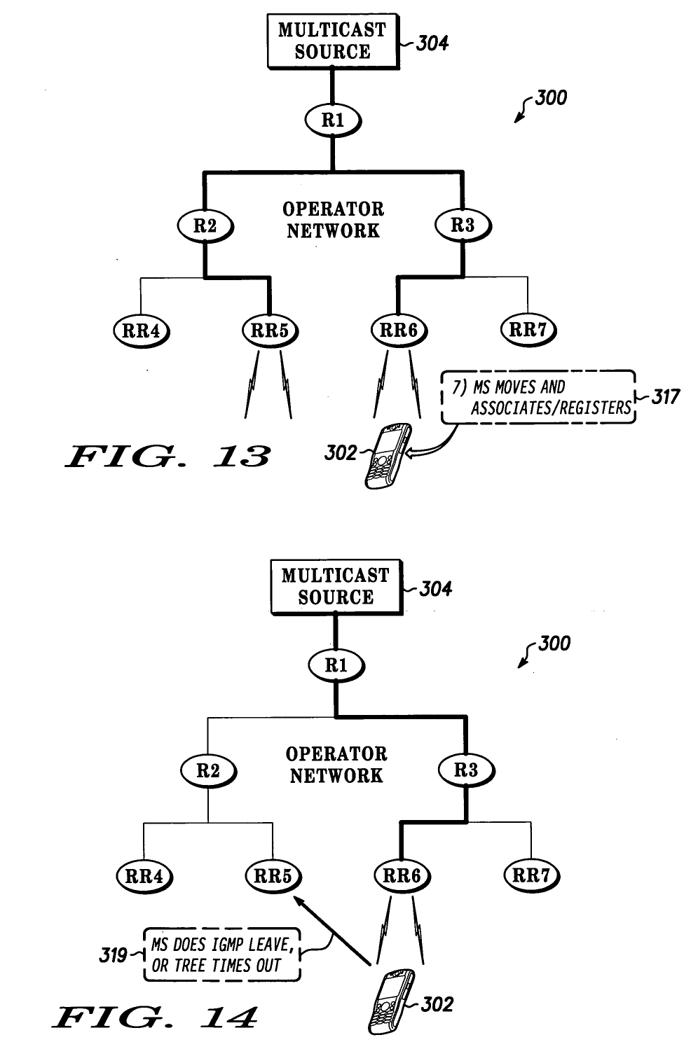

Well before the MS 302 moves to a potential target or destination cell/subnet, the MS 302 sends a Multicast Join message to the potential target access point at step 307. Referring to FIG. 11, at step 308, the ongoing call is being transmitted. At step 309, the MS 302 detects a potential target subnet. Referring now to FIG. 12, at step 311, before moving, the MS transmits a Multicast Join indication to the AP of the potential target or destination subnet. It does so while it is operating at the initial AP RR5. The access point RR6 joins the multicast tree 301 at step 313 and starts transmitting the multicast data (if it is not already doing so on behalf of another group member in the target cell). This is shown at step 315 where the access point RR6 transmits the call. If the MS 302 moves into a target cell, the multicast data is already available to the MS 302. Referring now to FIG. 13, the MS 302 moves to the access point RR6 at step 317 and receives the multicast packets. The MS 302 continues to receive multicast data from the initial access point RR5 after the execution of the handoff to the destination access point RR6 while the MS 302 is operating at the destination access point RR6.

Cleanup of the distribution tree at the old cell (and at potential target cells that the MS did not move to) can be done via an explicit IGMP or MLD Leave commands or by timeout at step 319 as shown in FIG. 14.

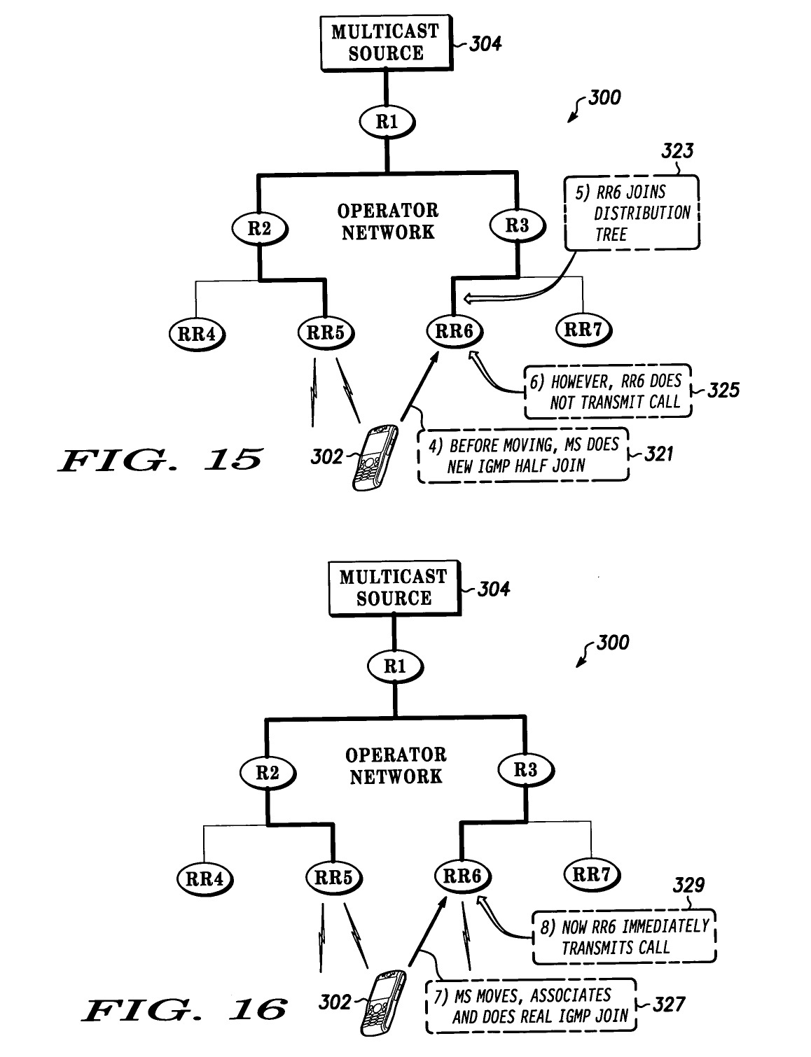

FIGS. 15 and 16 show a variation of the above-described approach. In this case, the use of wireless bandwidth for the transmission of multicast data in a target cell before the MS 302 moves to the cell is avoided. However, a modification of the access point and the communication protocol between the MS 302 and the access point is required, so that the MS 302 can transmit a “Half-Join” message.

In this approach, the MS 302 sends the Half-Join message to the target cell/subnet at step 321. A Half-Join message is different from a standard IGMP or MLD Multicast Join message. When the target radio access point RR6 receives the Half-Join message, it sets up the distribution tree 301 as it does when receiving a Multicast Join message but does not start transmitting the multicast data over the air at steps 323 and 325.

Alternatively, the MS 302 (operating at the initial access point) sends a standard IGMP or MLD Multicast Join message to the destination AP, before it is operating at the destination AP. The destination access point interprets the Multicast Join message received from an MS 302 that is not currently operating at that access point similarly to a Half-Join message. In other words, if the AP receives a Multicast Join message from an MS 302 that is not currently operating at the access point, the message is interpreted as to request the joining of the distribution tree 301 but does not require sending data over the radio link.

If the MS 302 does move to the target cell/subnet (see FIG. 16), the MS 302 sends a standard Multicast Join message or another message at step 327 that causes the radio access point to start transmitting any multicast data over the air at step 329.

An access point may inspect all session setup messages. In another approach, the access point inspects all session setup messages and determines the address that will be used for the session. The access point then determines whether an address used for the session is a multicast address. If so, the access point assumes that the target of the session setup message will join the multicast group for the at least the duration of the session.

Detection of the use of multicast during session is advantageous for several reasons. For instance, normally, an access point cannot setup a multicast distribution tree until it gets a Multicast Join message from one of the member MSs. With the present approach, the access point can detect a multicast session before the MS ever learns about it.

If the access point detects that a session will use a multicast address, the access point proactively sets up the multicast distribution tree. For example, in an IP system the access point acts (towards the core) as if it has received a Multicast Join message from the MS to which the setup message was directed (e.g. the access point will generate the PIM-SM messages needed for the radio access point to join the distribution tree for the multicast group).

An access point that inspects all messages to and from an MS can determine all the local member MSs of a group and all groups of an MS. The access point may store the determined groups of an MS in a profile or context for the MS that is stored in memory.

Furthermore, an access point may pass group membership information for all MSs assigned to that access point to neighbor access points, which then proactively join the multicast distribution tree in the network, even if those neighbors do not have an associated member MS.

In another approach, proactive joining of a multicast distribution tree is triggered by reception by the access point of a-location update. When an MS moves to a new cell while it is in sleep mode, the MS informs that new access point of its new location by sending a Location Update message. As a result, the new or destination access point may request the old access point to pass information about or context for the MS to the new access point. For example, the information may relate to authentication or other parameters such as multicast group memberships.

When an MS moves to a new access point and announces its presence, for example, through a Location Update if the MS is in sleep mode, the old access point also pass context of group membership information for the MS to the new access point. Alternatively, the MS may also be in HOLD or ON mode when the MS initiates a handover. The new access point performs analyses of the context or group membership information and acts as if the new access point has received a Multicast Join message from the MS for each of the MS's multicast groups and sets up, adjusts or joins the corresponding multicast distribution trees in the network, if not already set up for the groups.

When an MS that uses Mobile IP (P) when it changes access point or subnet, it must perform Mobile IP registration. The MS typically relies on its MIP home address for browsing, phone calls, and financial transactions. The MS may also use the home address for voice streaming and real-time sessions, which are also called high Quality-of-Service (QoS) sessions. For this reason, the MS will perform MIP registration with very high priority. In particular, the priority of the MIP registration is higher than that of multicast group Multicast Join messages. Hence, in previous systems, the MS performs MIP registration before the MS sends Multicast Join messages for its multicast groups.

A MIP registration may take a significant amount of time. If the MS is in a high Quality-of-Service (QoS) multicast session (dispatch group call) during the subnet change, there may be an audible gap in the conversation due to the execution of the MIP registration. Hence, in an alternate approach, an MS that uses Mobile IP for mobility may conditionally lower the priority of the MIP registration with its Home Agent. Specifically, when an MS that uses Mobile IP changes subnet and the MS is in high QoS session (voice call) while it changes subnet, and the session uses multicast on a local address to send and/or receive session data, then the device lowers the priority of the MIP registration so that the priority becomes lower than that of Multicast Join messages. Hence, the MS transmits a Multicast Join message for the multicast address used for the session before it does the MIP registration. Optionally, the MIP registration may be followed by Multicast Join messages for other multicast addresses for which there are no sessions at the time the MS changes subnet. Similarly, the MS may be “multi-homed” and have multiple IP addresses. The MS may have more than one MIP home address, and different IP home addresses may or may not have different MIP Home Agents (HAs). An MS with multiple MIP home addresses, when it changes subnet, performs more than one MIP registration with its MIP HA or HAs. When an MS with more than one MIP home address changes subnet while the MS is in a high QoS session that uses one of the MIP home addresses to send and/or receive session data, then the MS raises the priority of the MIP registration for the MIP home address for the high QoS session so that the priority becomes higher than that of the other MIP registrations it needs to perform.

While there have been illustrated and described particular embodiments of the present invention, it will be appreciated that numerous changes and modifications will occur to those skilled in the art, and it is intended in the appended claims to cover all those changes and modifications which fall within the true spirit and scope of the present invention.

What is claimed is:

1. A method in a radio access network (RAN) consisting of wireless access point (AP) devices and mobile station (MS) devices for the proactive setup of a multicast distribution tree comprising:
detecting, at a destination AP where a MS is not operating, an indication that the MS operating at an initial AP is a member of a multicast group, the indication being received via a RAN device; and
responsive to the detecting of the indication, establishing a multicast distribution tree for the multicast group that includes the destination AP.

2. The method of claim 1, wherein the detecting comprises receiving the indication from the initial AP.

3. The method of claim 2, wherein the detecting comprises receiving the indication from the initial AP, the indication being formed responsively to an occurrence of an event, the event selected from a group comprising:
a location update by the MS at the destination AP;
a handoff attempt by the MS to the destination AP;
an association of the MS with the initial AP, the destination AP being in close proximity to the initial AP;
a detection by the initial AP of a setup of a session for the MS where the session directs multicast data to the MS;
an establishment of a multicast distribution tree by the initial AP;
a context transfer for the MS from the initial AP to the destination AP;
a receipt of a Multicast Join message from the MS directed at the initial AP; and
a detection by the initial AP that the MS may move from the initial AP to the destination AP:

4. The method of claim 1, wherein the detecting comprises receiving the indication from the MS, the indication not being one of an Internet Group Management Protocol (IGMP) Membership Report message and a Multicast Listener Discovery (MLD) Multicast Listener Report message for the multicast group.

5. The method of claim 1, wherein the detecting comprises receiving an indication from the MS, the indication selected from a group comprised of:
a location update message by the MS at the destination AP;
a pre-association message of the MS with the destination AP;
a Half-Join message received from the MS; and
a handoff message by the MS to the destination AP.

6. The method of claim 1 further comprising:
receiving multicast data at the destination AP for the multicast group and not transmitting the multicast data; and
subsequently receiving an association request at the destination AP from the MS and after the receiving the association request, receiving subsequent multicast data at the destination AP for the multicast group and transmitting the subsequent multicast data.

7. The method of claim 6, wherein the association request is selected from a group comprised of:
a Multicast Join message for the multicast group;
a request message from the MS to operate at the destination AP; and.
one of an Association Request and Reassociation Request.

8. The method of claim 1, wherein the detecting comprises detecting setup of a session at the MS.

9. A wireless access point (AP) in a radio access network (RAN), the RAN including addition wireless APs and at least one mobile station (MS), the wireless APs comprising:
a detector receiving an input, the input indicating that a mobile station (MS) in the RAN is operating at an initial AP in the RAN that the at least one MS is not operating at the AP and is a member of a multicast group, the input being operably coupled to a RAN device;
a network interface, for connecting to a network;
a memory, coupled to the detector, the memory storing information for a multicast distribution tree; and
a controller coupled to the detector, the network interface and the memory, the controller receiving the input from the detector and joining the multicast distributor tree in the network, the multicast distribution tree directing multicast data for the multicast group to the wireless AP.

10. The wireless access point of claim 9, wherein the controller comprises means for detecting an occurrence of a session of the MS where the session directs multicast data to the MS.

11. The wireless access point of claim 9, wherein the controller comprises means for receiving an indication from the initial AP that the MS is a member of the multicast group.

12. The wireless access point of claim 9, wherein the RAN device comprises the MS.

13. The wireless access point of claim 9, wherein the RAN device comprises the initial AP.

14. A mobile station (MS) for receiving multicast data and operable to accelerate setup of a multicast distribution at a potential destination access point comprising:
a transceiver having an input;
a controller coupled to the transceiver, the controller receiving signals corresponding to the input of the transceiver, the signals being processed to determine a probability of an impending handoff of the MS to a potential destination access point, the signals being processed during operation of the MS with an initial access point (AP); and
means for transmitting, while operating at an initial AP, an indication to the potential access point that the mobile station is a member of a multicast group, the transmission of the indication causing the potential destination access point to join a distribution tree.

15. The mobile station of claim 14, wherein the indication is chosen from a group comprising an Internet Group Management Protocol (IGMP) Membership Report message; a Multicast Listener Discovery (MLD) Multicast Listener Report message; and an Half-Join message.

16. The mobile station of claim 14, wherein the transmission of the indication does not result in an Over The Air transmission by the potential AP of multicast data received from the distribution tree.

17. A mobile station (MS) for receiving multicast data on a multicast address and for receiving unicast data on a first Mobile Internet Protocol (MIP) home address and operable to accelerate setup of a multicast distribution at a potential destination access point (AP) comprising:
a transceiver having an input;
a controller coupled to the transceiver, the controller receiving signals corresponding to the input of the transceiver, the signals being processed to determine a need for a handoff of the MS to a destination AP, the signals being processed during operation of the MS with an initial AP;
means for executing the handoff of the MS to the destination AP;
means for transmitting an indication to the destination AP that the mobile station is a member of a multicast group, the transmission of the indication causing the destination AP to join a distribution tree;
means for following the transmission of the indication with the initiation of a M[P registration for the first MIP home address if the MS is in a multicast session at a time of the execution of the handoff; and
means for preceding the transmission of the indication with the initiation of the MIP registration for the first MIP home address if the MS is not in a multicast session at a time of the execution of the handoff.

18. The MS of claim 17 further operable for receiving unicast data on a second M[P home address and further comprising:
means for following the transmission of the initiation of the MIP registration for the first MIP home address with the initiation of a MIP registration for the second home address if the MS is in a high Quality-of Service (QoS) session on the MIP home address at a time of execution of the handoff; and
means for preceding the transmission of the initiation of the MIP registration for the first MIP home address with the initiation of a M[P registration for the second MIP home address if the MS is in a high QoS session on the second MIP home address at a time of execution of the handoff.

19. A mobile station for receiving multicast data from an initial access point (AP) and operable to accelerate setup of a multicast distribution at a destination AP comprising:
a transceiver having an output; and
a controller, coupled to the transceiver, and executing a handoff to a destination AP, the controller transmitting an indication on the output of the transceiver to the destination access point, the indication comprising information indicating that the MS is a member of a multicast group, wherein the controller further comprises means for continuing to receive multicast data from the initial AP after execution of the handoff to the destination AP, while operating at the destination AP.

20. A wireless access point (AP) in a radio access network (RAM) comprising:
a detector receiving an input, the input indicating the reception of a session setup message directed to a mobile station (MS) in the RAN, the session setup message indicating that the MS is a member of a multicast group;
a network interface coupled to a network;
a memory, coupled to the detector, the memory storing a multicast distribution tree; and
a controller coupled to the detector, the network interface, and the memory, the controller receiving the input from the detector and joining the multicast distribution tree in the memory, the multicast distribution tree directing multicast data for the multicast group to the wireless AP.
